(19) United States
(12) Patent Application Publication
(10) Pub. No.: US 2021/0409717 A1
(43) Pub. Date: Dec. 30, 2021

(54) DISPLAY CONTROL APPARATUS, DISPLAY APPARATUS, DISPLAY CONTROL SYSTEM, AND STORAGE MEDIUM

(71) Applicant: DENSO CORPORATION, Kariya-city (JP)

(72) Inventors: Toshitaka ASAI, Kariya-city (JP); Mitsuo TAMAGAKI, Kariya-city (JP); Yoshitaka ADACHI, Kariya-city (JP); Naoki YOKOTA, Kariya-city (JP); Ken AIDA, Kariya-city (JP); Satoshi KATANO, Kariya-city (JP)

(21) Appl. No.: 17/469,371

(22) Filed: Sep. 8, 2021

Related U.S. Application Data
(63) Continuation of application No. PCT/JP2020/006294, filed on Feb. 18, 2020.

(30) Foreign Application Priority Data
Mar. 13, 2019 (JP) 2019-045889

(51) Int. Cl. H04N 19/136; G06F 21/51

(52) U.S. Cl. CPC H04N 19/136; G06F 21/51; B60K 37/02; B60K 2370/52; B60K 2370/165

(57) ABSTRACT

In a display control apparatus, it is determine whether video data transmitted to a display apparatus is reliable or unreliable. In response to determining that the video data transmitted to the display apparatus is unreliable, a predetermined process is executed.

### CROSS REFERENCE TO RELATED APPLICATIONS

The present application is a continuation application of International Patent Application No. PCT/JP2020/006294 filed on Feb. 18, 2020, which designated the U.S. and claims the benefit of priority from Japanese Patent Application No. 2019-045889 filed on Mar. 13, 2019. The entire disclosures of all of the above applications are incorporated herein by reference.

### TECHNICAL FIELD

The present disclosure relates to a display control apparatus, a display apparatus, a display control system, and a storage medium.

### BACKGROUND

There is known a display control system including (i) a display apparatus with a display and (ii) a display control apparatus for controlling a video displayed on the display in the display apparatus.

In this type of display control system, when video data is transmitted from the display control apparatus to the display apparatus, the video corresponding to the video data is displayed on the display apparatus. For example, if the display apparatus is an in-vehicle meter apparatus, video data is transmitted from the display control apparatus to the meter apparatus, so that, for example, videos such as the remaining amount of fuel and the mileage are displayed on the meter apparatus.

### SUMMARY

According to an example of the present disclosure, a display control apparatus is provided as follows. The display control apparatus is configured to determine whether video data transmitted to a display apparatus is reliable or unreliable. In response to determining that the video data transmitted to the display apparatus is unreliable, a predetermined process is executed.

### BRIEF DESCRIPTION OF DRAWINGS

The objects, features, and advantages of the present disclosure will become more apparent from the following detailed description made with reference to the accompanying drawings. In the drawings:

FIG. 1 is a functional block diagram showing an overall configuration of a first embodiment;

FIG. 2 is a diagram showing a meter apparatus;

FIG. 3 is a diagram showing a configuration of a controller of a display control ECU and a controller of a meter apparatus;

FIG. 4 is a diagram (No. 1) showing a sequence of a process;

FIG. 5 is a diagram (No. 2) showing a sequence of a process;

FIG. 6 is a diagram (No. 3) showing a sequence of a process;

FIG. 7 is a diagram (No. 4) showing a sequence of a process;

FIG. 8 is a diagram (No. 5) showing a sequence of a process;

FIG. 9 is a diagram (No. 6) showing a sequence of a process;

FIG. 10 is a diagram (No. 7) showing a sequence of a process according to a second embodiment;

FIG. 11 is a diagram (No. 8) showing a sequence of a process;

FIG. 12 is a diagram showing a signal between a controller and a signal conversion IC according to a third embodiment;

FIG. 13 is a diagram (No. 9) showing a sequence of a process;

FIG. 14 is a diagram (No. 10) showing a sequence of a process;

FIG. 15 is a diagram (No. 11) showing a sequence of a process; and

FIG. 16 is a diagram (No. 12) showing a sequence of a process.

### DETAILED DESCRIPTION

### First Embodiment

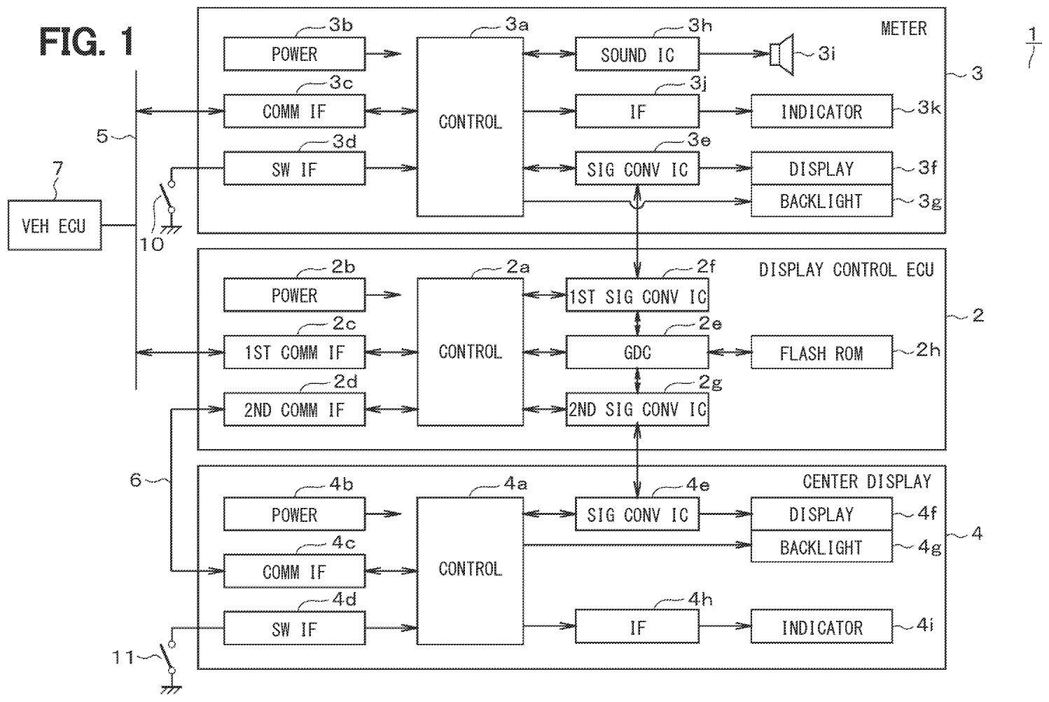

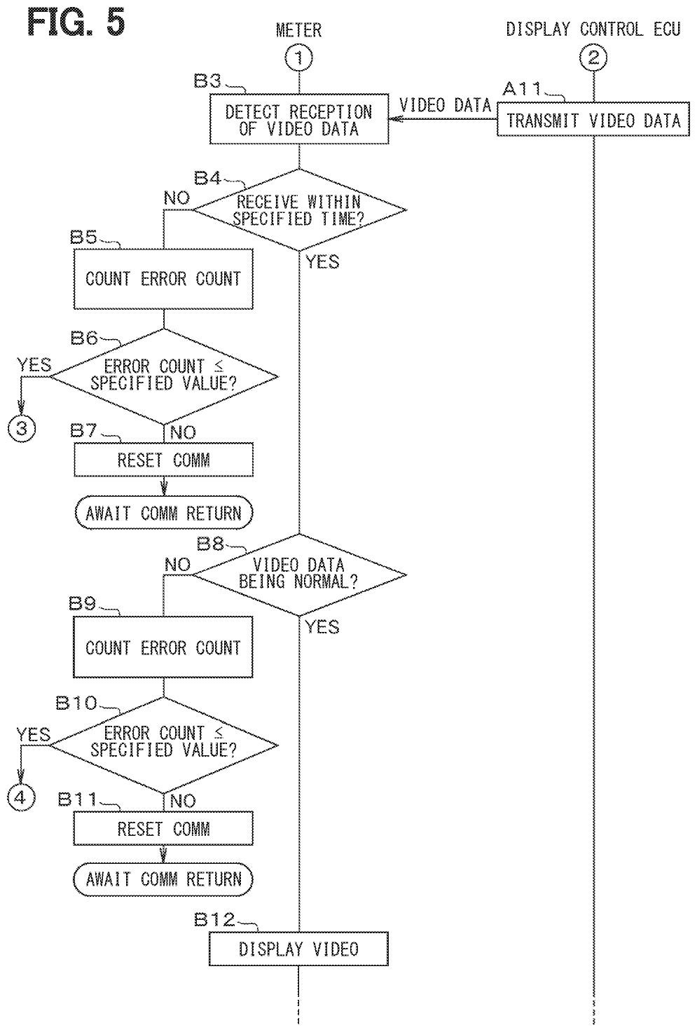

Hereinafter, a first embodiment will be described with reference to FIGS. 1 to 9. As shown in FIG. 1, a display control system 1 includes (i) a display control ECU (Electronic Control Unit) 2 (i.e., display control apparatus), (ii) a meter apparatus 3 (i.e., display apparatus) arranged in front of the driver's seat, and (iii) a center display apparatus 4 (i.e., display apparatus) arranged on the center console between the driver's seat and the passenger seat. The display control ECU 2 includes an HMI (Human Machine Interface) function in addition to the display control function, and functions as an HCU (HMI control unit). The display control ECU 2 is connected to the meter apparatus 3 via the in-vehicle network 5 so as to be capable of data communication, and is also connected to the center display apparatus 4 via the data communication line 6 so as to be capable of data communication. Further, the display control ECU 2 and the meter apparatus 3 are connected to the vehicle side ECU 7 via the in-vehicle network 5 so as to be capable of data communication. The in-vehicle network 5 is, for example, CAN (Controller Area Network) (registered trademark) or the like.

The display control ECU 2 centrally controls the display of videos in the meter apparatus 3 and the center display apparatus 4 by transmitting video data to the meter apparatus 3 and the center display apparatus 4. By receiving the video data transmitted from the display control ECU 2, the meter apparatus 3 displays a video related to safety and security such as the remaining amount of fuel and the mileage. By receiving the video data transmitted from the display control ECU 2, the center display apparatus 4 displays a video related to infotainment such as audio information and navigation information.

The present embodiment illustrates the configuration in which the display control ECU 2 centrally controls the display of videos on the two display apparatuses of the meter apparatus 3 and the center display apparatus 4. However, the display control ECU 2 may be configured to control the display of videos on one display apparatus, or may be configured to centrally control the display of videos on three or more display apparatuses. The display apparatus of which the display videos are controlled by the display control ECU 2 may be a head-up display apparatus, a multi-information display apparatus, a mobile device such as a smartphone or a tablet brought into the vehicle interior, or the like.

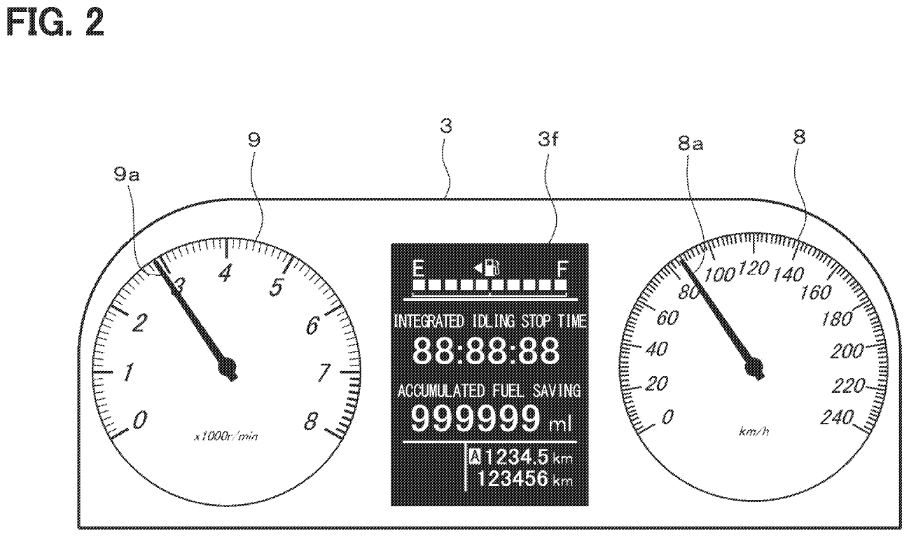

As shown in FIG. 2, the meter apparatus 3 includes (i) an analog pointer type vehicle speed meter 8 in which the pointer 8a is rotationally driven in conjunction with the vehicle speed, (ii) an analog pointer type tachometer 9 in which the pointer 9a is rotationally driven in conjunction with the engine speed, and (iii) a display 3f that displays various vehicle states. The display 3f is arranged between the vehicle speed meter 8 and the tachometer 9. In the state where the meter apparatus 3 is activated, the display 3f can display (i) the remaining amount of fuel, (ii) the integrated idling stop time, (iii) the accumulated fuel saving, (iv) the ODO distance (123456 km in the example of FIG. 2), and (v) the TRIP distance (1234.5 km in the example of FIG. 2), as videos. The meter apparatus 3 may have a configuration in which the vehicle speed and the number of rotations can be also displayed by videos, or may have a so-called full display configuration.

The display control ECU 2 includes (i) a controller 2a (which may also be referred to as a controller unit, a first controller, or a first controller unit), (ii) a power supply circuit 2b, (iii) a first communication IF unit 2c, (iv) a second communication IF unit 2d, (v) a GDC (Graphic Display Controller) 2e, (vi) a first signal conversion IC (Integrated Circuit) 2f (which may also be referred to as a video data transmitter or a video data transmitter unit), (vii) a second signal conversion IC 2g (which may also be referred to as a video data transmitter or a video data transmitter unit), and (viii) a flash ROM (Read Only Memory) 2h. Further, the first signal conversion IC 2f and the second signal conversion IC 2g may each function not only as a transmitter transmitting data but also as a receiver receiving data; namely the first signal conversion IC 2f and the second signal conversion IC 2g may each function as a transceiver communicating data.

The controller 2a is mainly composed of an MPU (Micro Processing Unit), executes a control program, and controls the overall operation of the display control ECU 2. The control program executed by the controller 2a includes a display control program. The power supply circuit 2b supplies operating power to each functional block inside the display control ECU 2. The first communication IF unit 2c controls data communication with the meter apparatus 3 via the in-vehicle network 5. The second communication IF unit 2d controls data communication with the center display apparatus 4 via the data communication line 6. The GDC 2e reads the data stored in the flash ROM 2h and processes the read data to generate video data.

When the first signal conversion IC 2f receives video data from the GDC 2e, the first signal conversion IC 2f transmits the received video data to the meter apparatus 3 by LVDS (Low Voltage Differential Signaling) communication. When the second signal conversion IC 2g receives video data from the GDC 2e, the second signal conversion IC 2g transmits the received video data to the center display apparatus 4 by LVDS communication. LVDS communication includes GVIF (Gigabit Video Interface), GMSL (Gigabit Multimedia Serial Link), HDMI (High-Definition Multimedia Interface) (registered trademark), Ethernet (registered trademark), and the like.

The meter apparatus 3 includes (i) a controller 3a (which may also be referred to as a controller unit, a second controller, or a second controller unit), (ii) a power supply circuit 3b, (iii) a communication IF unit 3c, (iv) a switch IF unit 3d, (v) a signal conversion IC 3e (which may also be referred to as a video data receiver or a video data receiver unit), (vi) a display 3f (display unit), (vii) a backlight 3g, (viii) a sound IC 3h, (ix) a speaker 3i, (x) an IF unit 3j, and (xi) an indicator 3k. Further, the signal conversion IC 3e may function not only as a receiver receiving data but also as a transmitter transmitting data; namely the signal conversion IC 3e may function as a transceiver communicating data.

The controller 3a is mainly composed of a MPU, executes a control program, and controls the overall operation of the meter apparatus 3. The control program executed by the controller 3a includes a display program. The power supply circuit 3b supplies operating power to each functional block inside the meter apparatus 3. The communication IF unit 3c controls data communication with the display control ECU 2 via the in-vehicle network 5. The switch IF unit 3d detects the on/off of the ODO/TRIP switch 10 and outputs the detection result to the controller 3a. When the signal conversion IC 3e receives the video data transmitted from the display control ECU 2, the signal conversion IC 3e converts the received video data in accordance with the standard of the meter apparatus 3 and outputs the converted video data to the display 3f.

The display 3f is, for example, a TFT (Thin-Film-Transistor) liquid crystal display; when video data is received from the signal conversion IC 3e, the received video data is decoded and the video corresponding to the video data is displayed. The backlight 3g is turned on when a lighting on command is received from the controller 3a, and is turned off when a lighting off command is received from the controller 3a. When the sound IC 3h receives a sound output command from the controller 3a, the sound IC 3h outputs the sound from the speaker 3i according to the received sound output command. When the IF unit 3j receives a display command from the controller 3a, the IF unit 3j displays the indicator 3k according to the received display command.

The center display apparatus 4 includes (i) a controller 4a (which may also be referred to as a controller unit, a second controller, or a second controller unit), (ii) a power supply circuit 4b, (iii) a communication IF unit 4c, (iv) a switch IF unit 4d, (v) a signal conversion IC 4e (which may also be referred to as a video data receiver or a video data receiver unit), (vi) a display 4f (display unit), (vii) a backlight 4g, (viii) an IF unit 4h, and (ix) an indicator 4i. Further, the signal conversion IC 4e may function not only as a receiver receiving data but also as a transmitter transmitting data; namely the signal conversion IC 4e may function as a transceiver communicating data.

The controller 4a is mainly composed of the MPU, executes a control program, and controls the overall operation of the center display apparatus 4. The control program executed by the controller 4a includes a display program. The power supply circuit 4b supplies operating power to each functional block inside the center display apparatus 4. The communication IF unit 4c controls data communication with the display control ECU 2 via the data communication line 6. The switch IF unit 4d detects the on/off of the external switch 11 and outputs the detection result to the controller 4a. When the signal conversion IC 4e receives the video data transmitted from the display control ECU 2, the signal conversion IC 4e converts the received video data in accordance with the standard of the center display apparatus 4, and outputs the converted video data to the display 4f.

The display 4f is, for example, a TFT liquid crystal display, and when video data is received from the signal conversion IC 4e, the received video data is decoded and the video corresponding to the video data is displayed. The backlight 4g is turned on when a lighting on command is received from the controller 4a, and is turned off when a lighting off command is received from the controller 4a. When the IF unit 4h receives a display command from the controller 4a, the IF unit 4h displays the indicator 4i according to the received display command.

The first signal conversion IC 2f of the display control ECU 2 and the signal conversion IC 3e of the meter apparatus 3 are connected by a coaxial cable or a differential cable. The first signal conversion IC 2f of the display control ECU 2 converts video data, serial data (UART, I2C, SPI, etc.) and general-purpose output data into high-speed serial signals. The converted high-speed serial signal is transmitted to the signal conversion IC 3e of the meter apparatus 3. When the signal conversion IC 3e of the meter apparatus 3 receives a high-speed serial signal from the first signal conversion IC 2f of the display control ECU 2, the signal conversion IC 3e reconverts the received high-speed serial signal and separates the reconverted high-speed serial signal into video data, serial data, and general-purpose output data for output.

Further, the signal conversion IC 3e of the meter apparatus 3 converts the serial data and the general-purpose output data into a low-speed serial signal, and transmits the converted low-speed serial signal to the first signal conversion IC 2f of the display control ECU 2. When the first signal conversion IC 2f of the display control ECU 2 receives a low-speed serial signal from the signal conversion IC 3e of the meter apparatus 3, it reconverts the received low-speed serial signal and separates the reconverted low-speed serial signal into serial data and general-purpose output data for output.

The second signal conversion IC 2g of the display control ECU 2 and the signal conversion IC 4e of the center display apparatus 4 are also connected by a coaxial cable or a differential cable. The relation between the second signal conversion IC 2g and the signal conversion IC 4e is thus the same as the relation between the first signal conversion IC 2f of the display control ECU 2 and the signal conversion IC 3e of the meter apparatus 3.

The above configuration is a configuration in which the meter apparatus 3 and the center display apparatus 4 do not have a GDC and the display of videos in the meter apparatus 3 and the center display apparatus 4 is controlled by the display control ECU 2. In such a configuration, as mentioned above, the following problems are assumed. That is, in the meter apparatus 3 and the center display apparatus 4, it is impossible to determine whether the images displayed on the displays 3f and 4f are correct videos or incorrect videos. Therefore, there is a demand for a mechanism for determining the reliability of video data transmitted from the display control ECU 3 to the meter apparatus 3 and the center display apparatus 4. In view of this point, the following configuration is adopted in the present embodiment. Hereinafter, the relation between the display control ECU 2 and the meter apparatus 3 will be described, but the same applies to the relation between the display control ECU 2 and the center display apparatus 4.

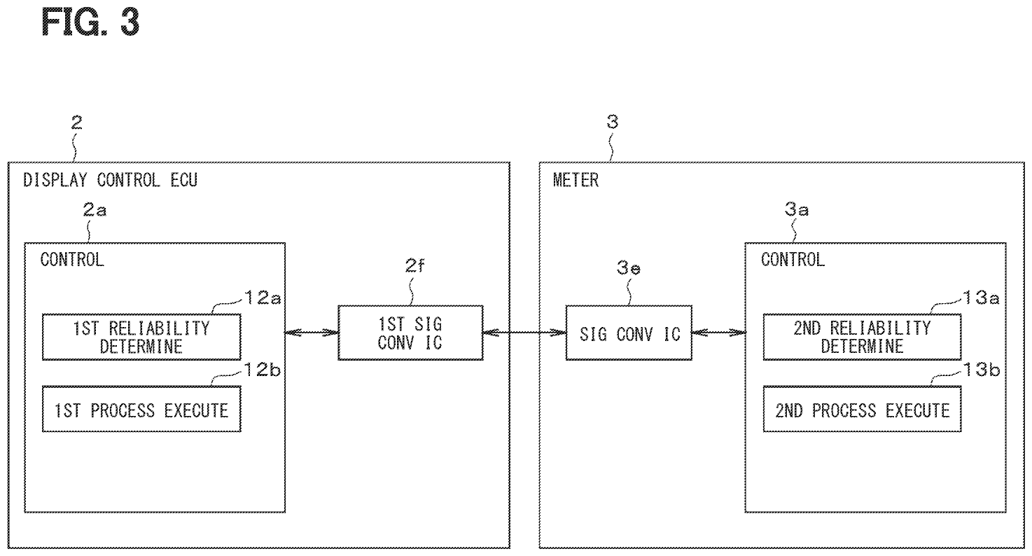

As shown in FIG. 3, in the display control ECU 2, the controller 2a includes a first reliability determination unit 12a (reliability determination unit) and a first predetermined process execution unit 12b. The first reliability determination unit 12a determines communication interruption or communication abnormality of the signal transmitted or received between the display control ECU 2 and the meter apparatus 3, thereby determining the reliability of the video data transmitted from the first signal conversion IC 2f to the meter apparatus 3. When the first reliability determination unit 12a determines that the video data transmitted from the signal conversion IC 2e to the meter apparatus 3 is unreliable, the first predetermined process execution unit 12b executes a first predetermined process. The first predetermined process execution unit 12b resets the first signal conversion IC 2f, or causes the meter apparatus 3 to perform a notification operation or to turn off the backlight 3g as the first predetermined process.

In the meter apparatus 3, the controller 3a includes a second reliability determination unit 13a (reliability determination unit) and a second predetermined process execution unit 13b. The second reliability determination unit 13a determines communication interruption or communication abnormality of the signal transmitted or received between the meter apparatus 3 and the display control ECU 2, thereby determining the reliability of the video data received by the signal conversion IC 3e from the display control ECU 2. When the second reliability determination unit 13a determines that the video data received from the display control ECU 2 by the signal conversion IC 3e is not reliable, the second predetermined process execution unit 13b executes a second predetermined process. The second predetermined process execution unit 13b resets the signal conversion IC 3e, performs a notification operation, or turns off the backlight 3g as the second predetermined process.

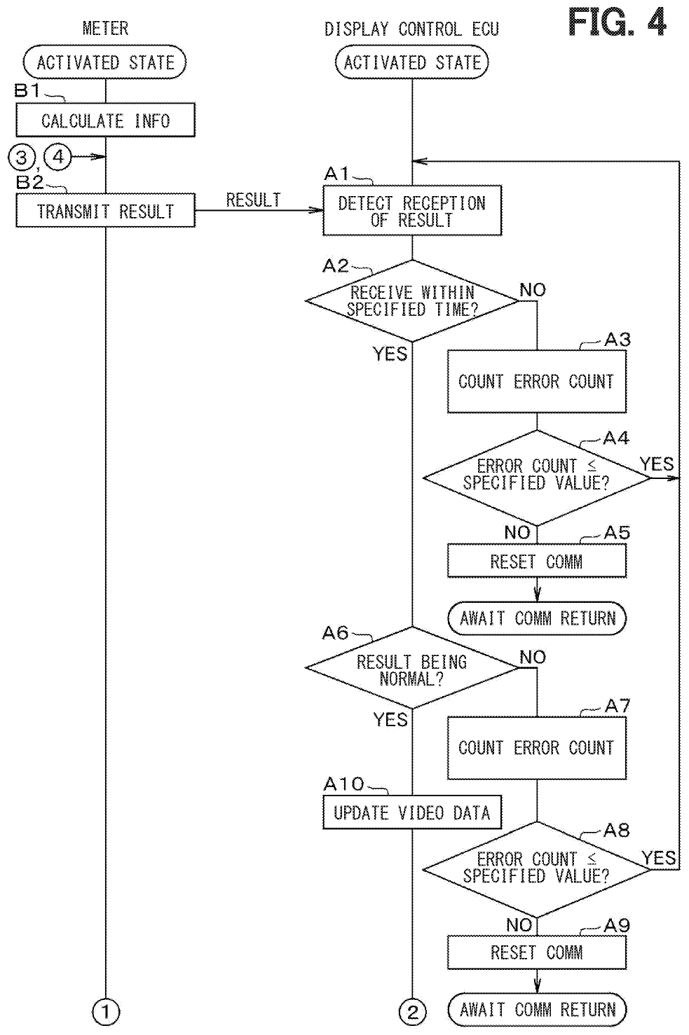

Next, the operation of the above configuration will be described with reference to FIGS. 4 to 9. Here, a case will be described in which the display control ECU 2 and the meter apparatus 3 determine the calculation result and the video data received and transmitted after being activated, and thereby determine the reliability of the video data.

In the meter apparatus 3, the controller 3a calculates information such as vehicle communication and ON/OFF of the ODO/TRIP switch 10 in the activated state (B1), and causes the signal conversion IC 3e to transmit the calculated calculation result to the display control ECU 2 (B2).

In the display control ECU 2, when the controller 2a detects the reception of the calculation result from the meter apparatus 3 by the first signal conversion IC 2f in the activated state (A1), the controller 2a determines whether or not the calculation result is received within a specified time specified in advance (A2, first reliability determination procedure). When the controller 2a determines that the calculation result is not received within the specified time (A2: NO), the controller 2a counts up the error count value, holds the previous value (A3), and determines whether or not the counted-up error count value is equal to or less than the specified value (A4, first reliability determination procedure). When the controller 2a determines that the error count value is equal to or less than the specified value (A4: YES), the controller 2a returns to step A1 and repeats step A1 and subsequent steps.

When the controller 2a determines that the error count value is not equal to or less than the specified value (A4: NO), the controller 2a resets the first signal conversion IC 2f and resets the communication between the display control ECU 2 and the meter apparatus 3 (A5, first predetermined process execution procedure). That is, when the error count value indicating the number of times the calculation result consecutively fails to be received within the specified time exceeds the specified value, the controller 2a determines that the communication is interrupted and resets the communication between the display control ECU 2 and the meter apparatus 3. When the controller 2a resets the communication between the display control ECU 2 and the meter apparatus 3, the controller 2a shifts to the communication return standby state and waits for the communication return.

When the controller 2a determines that the calculation result is received within the specified time (A2: YES), for example, it calculates a checksum and determines whether or not the calculation data constituting the calculation result is normal (A6, first reliability determination procedure). When the controller 2a determines that the calculation data is not normal (A6: NO), the controller 2a counts up the error count value, holds the previous value (A7), and determines whether or not the counted-up error count value is equal to or less than the specified value (A8, first reliability determination procedure). When the controller 2a determines that the error count value is equal to or less than the specified value (A8: YES), the controller 2a returns to step A1 and repeats step A1 and subsequent steps.

When the controller 2a determines that the error count value is not equal to or less than the specified value (A8: NO), the controller 2a resets the first signal conversion IC 2f and resets the communication between the display control ECU 2 and the meter apparatus 3 (A9, first predetermined process execution procedure). That is, when the controller 2a determines a communication abnormality because the error count value indicating the number of times the calculation data consecutively fails to be normal exceeds the specified value, the controller 2a resets the communication between the display control ECU 2 and the meter apparatus 3. When the controller 2a resets the communication between the display control ECU 2 and the meter apparatus 3, the controller 2a shifts to the communication return standby state and waits for the communication return. When the controller 2a determines that the calculated data is normal (A6: YES), the controller 2a updates the video data using the calculated data (A10), and causes the signal conversion IC 2e to transmit the video data to the meter apparatus (A11).

In the meter apparatus 3, when the controller 3a detects the reception of the video data from the display control ECU 2 by the signal conversion IC 3e (B3), the controller 3a determines whether or not the video data is received within a specified time specified in advance (B4, second reliability determination procedure). When the controller 3a determines that the video data is not received within the specified time (B4: NO), the controller 3a counts up the error count value, holds the previous value (B5), and determines whether or not the counted-up error count value is equal to or less than the specified value (B6, second reliability determination procedure).

When the controller 3a determines that the error count value is equal to or less than the specified value (B6: YES), the controller 3a returns to step B2 and repeats step B2 and subsequent steps. When the controller 3a determines that the error count value is not equal to or less than the specified value (B6: NO), the controller 3a resets the signal conversion IC 3e and resets the communication between the meter apparatus 3 and the display control ECU 2 (B7, second predetermined process execution procedure). That is, when the controller 3a determines that the communication is interrupted because the error count value indicating the number of times the video data consecutively fails to be received within the specified time exceeds the specified value, the controller 3a resets the communication between the meter apparatus 3 and the display control ECU 2. When the controller 3a resets the communication between the meter apparatus 3 and the display control ECU 2, the controller 3a shifts to the communication return standby state and waits for the communication return.

When the controller 3a determines that the video data is received within the specified time (B4: YES), for example, the controller 3a calculates a checksum and determines whether or not the video data is normal (B8, second reliability determination procedure). When the controller 3a determines that the video data is not normal (B8: NO), the controller 3a counts up the error count value, holds the previous value (B9), and determines whether or not the counted-up error count value is equal to or less than the specified value (B10, second reliability determination procedure). When the controller 3a determines that the error count value is equal to or less than the specified value (B10: YES), the controller 3a returns to step B2 and repeats step B2 and subsequent steps.

When the controller 3a determines that the error count value is not equal to or less than the specified value (B10: NO), the controller 3a resets the signal conversion IC 3e, and resets the communication between the meter apparatus 3 and the display control ECU 2 (B11, second predetermined process execution procedure). That is, when the controller 3a determines a communication abnormality because the error count value indicating the number of times the video data consecutively fails to be normal exceeds the specified value, the controller 3a resets the communication between the meter apparatus 3 and the display control ECU 2. When the controller 3a resets the communication between the meter apparatus 3 and the display control ECU 2, the controller 3a shifts to the communication return standby state and waits for the communication return. When the controller 3a determines that the video data is normal (B8: YES), the controller 3a displays the video corresponding to the video data on the display 3f (B12).

As described above, in the display control ECU 2, the controller 2a determines a communication interruption because the number of times the calculation result consecutively fails to be received within the specified time exceeds the specified value. Further the controller 2a determines a communication error because the number of times the calculation data consecutively fails to be normal exceeds the specified value. When such a communication interruption or a communication error is determined, the first signal conversion IC 2f is reset, and the communication between the display control ECU 2 and the meter apparatus 3 is reset. Further, in the meter apparatus 3, the controller 3a determines a communication interruption because the number of times the video data consecutively fails to be received within the specified time exceeds the specified value. Further the controller 3a determines a communication error because the number of times the calculation data consecutively fails to be normal exceeds the specified value. When such a communication interruption or a communication error is determined, the signal conversion IC 3e is reset, and the communication between the meter apparatus 3 and the display control ECU 2 is reset.

The above description describes a case where the display control ECU 2 resets the communication between the display control ECU 2 and the meter apparatus 3 when the controller 2a determines a communication interruption or a communication abnormality. However, the meter apparatus 3 may be made to perform a notification operation, the backlight 3g may be turned off, or a combination thereof may be performed.

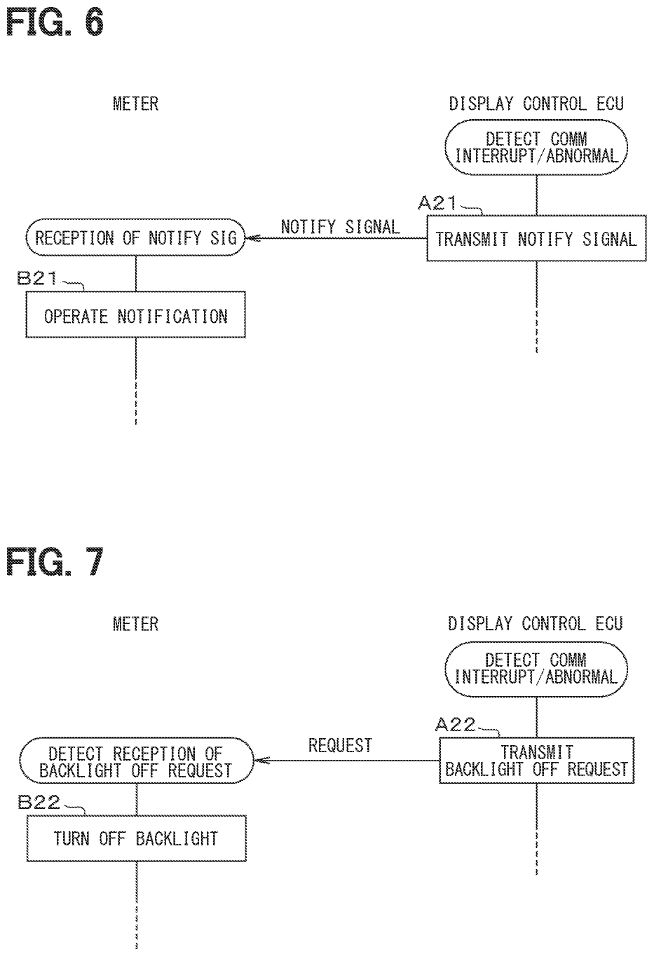

As shown in FIG. 6, in the display control ECU 2, when the controller 2a determines the communication interruption or the communication abnormality, the first signal conversion IC 2f transmits a notification signal to the meter apparatus 3 (A21). In the meter apparatus 3, when the controller 3a detects the reception of the notification signal from the display control ECU 2, it executes a notification operation for notifying a communication interruption or a communication abnormality (B21). As a notification operation, the controller 3a displays, for example, a warning icon on the display 3f, outputs a warning sound from the speaker 3i, blinks the indicator 3k, or performs ambient lighting to light the outer peripheral portion of the meter apparatus 3 in red. For example, there may be a case where the display control ECU 2 and the meter apparatus 3 are configured to be capable of wireless communication with mobile devices such as smartphones and tablets by Bluetooth (registered trademark), WiFi (registered trademark), or the like. In such a case, the controller 2a may transmit the notification signal directly to the mobile device or transmit the notification signal to the mobile device via the meter apparatus 3. As a result, the mobile device may be made to perform a notification operation for notifying a communication interruption or a communication abnormality.

As shown in FIG. 7, in the display control ECU 2, when the controller 2a determines the communication interruption or the communication abnormality, the first signal conversion IC 2f is caused to transmit the backlight turning off request to the meter apparatus 3 (A22). In the meter apparatus 3, when the controller 3a detects the reception of the backlight turning off request from the display control ECU 2, the controller 3a turns off the backlight 3g (B22).

Further, in the meter apparatus 3, the case where the communication between the display control ECU 2 and the meter apparatus 3 is reset when the controller 3a determines the communication interruption or the communication abnormality has been described. However, a notification operation may be performed, the backlight 3g may be turned off, or a combination thereof may be performed.

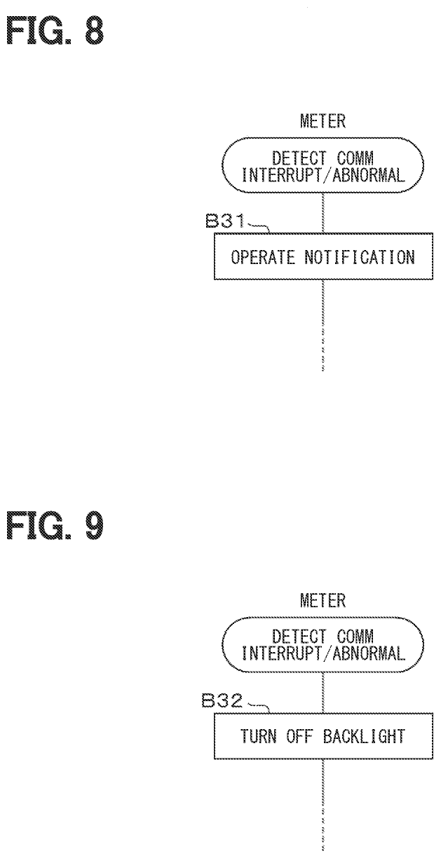

As shown in FIG. 8, in the meter apparatus 3, when the controller 3a determines the communication interruption or the communication abnormality, the controller 3a executes a notification operation for notifying the communication interruption or the communication abnormality (B31). In this case as well, as a notification operation, for example, the controller 3a displays a warning icon on the display 3f, outputs a warning sound from the speaker 3i, blinks the indicator 3k, or performs ambient lighting to light the outer peripheral portion of the meter apparatus 3 in red. Further, for example, there is a case where the meter apparatus 3 or the display control ECU 2 is configured to be capable of wireless communication with a mobile device such as a smartphone or tablet by Bluetooth, WiFi, or the like. In such a case, the controller 3a may transmit the notification signal directly to the mobile device or transmit the notification signal to the mobile device via the display control ECU 2. As a result, the mobile device may be made to perform a notification operation for notifying a communication interruption or a communication abnormality.

As shown in FIG. 9, in the meter apparatus 3, when the controller 3a determines the communication interruption or the communication abnormality, the backlight 3g is turned off (B32).

As described above, according to the first embodiment, the following effects can be obtained. In the display control ECU 2, when receiving a calculation result from the meter apparatus 3, a communication interruption or a communication abnormality is determined. Thereby, it is determined that the video data transmitted from the display control ECU 2 to the meter apparatus 3 is unreliable. Thereby, the communication between the display control ECU 2 and the meter apparatus 3 is reset, the meter apparatus 3 is made to perform a notification operation, or turn off the backlight 3g. As a result, when it is determined that the video data transmitted from the display control ECU 2 to the meter apparatus 3 is unreliable, it is possible to take appropriate measures.

Further, in the meter apparatus 3, when receiving video data from the display control ECU 2, communication interruption or communication abnormality is determined. Then, it is determined that the video data transmitted from the display control ECU 2 to the meter apparatus 3 is unreliable. Thereby the communication between the meter apparatus 3 and the display control ECU 2 is reset, a notification operation is performed, and the backlight 3g is turned off. As a result, when it is determined that the video data transmitted from the display control ECU 2 to the meter apparatus 3 is unreliable, it is possible to take appropriate measures.

### Second Embodiment

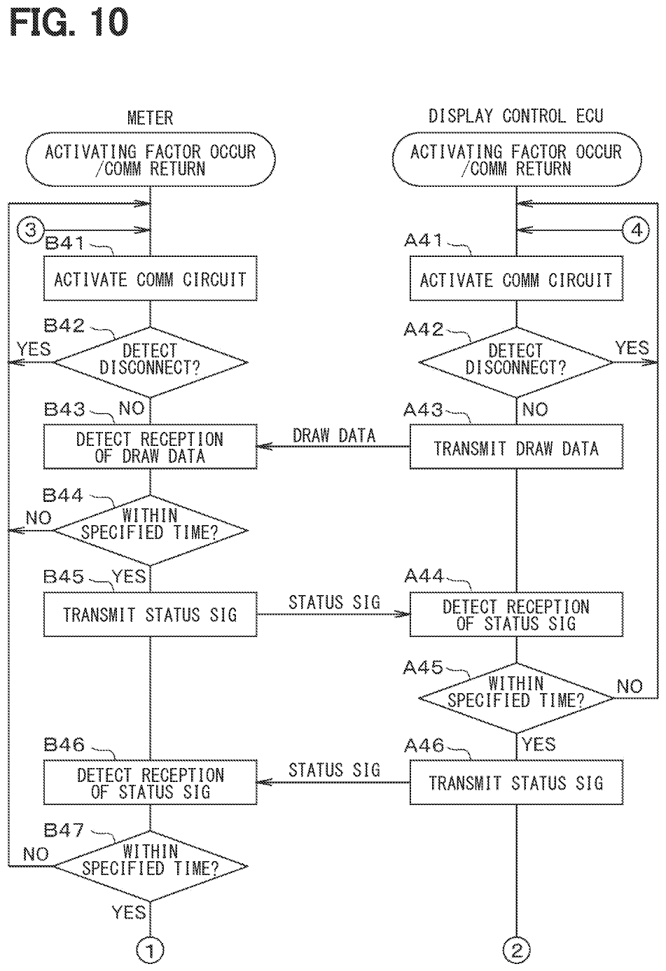

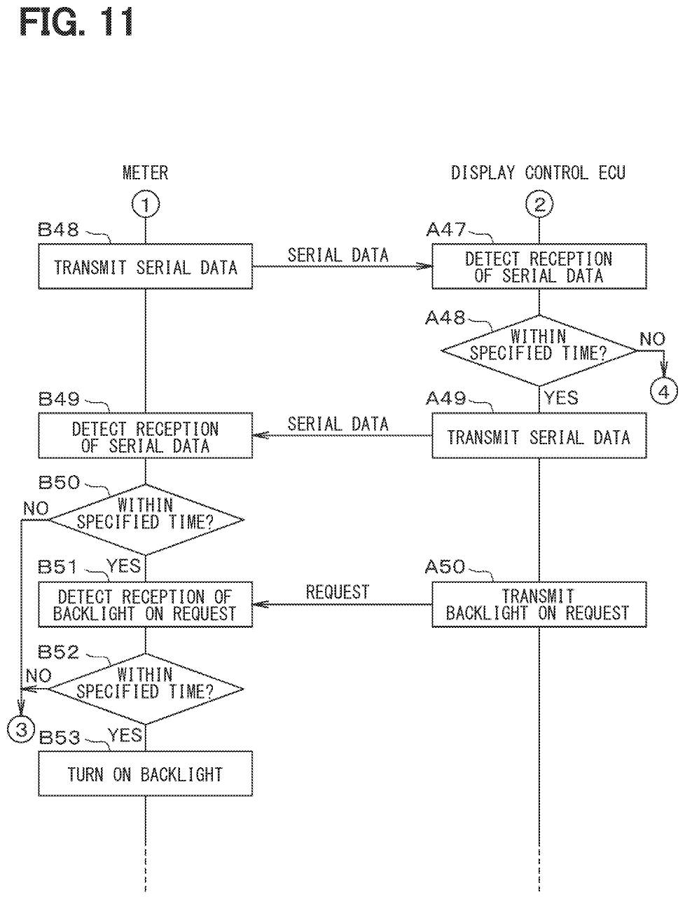

Next, a second embodiment will be described with reference to FIGS. 10 and 11. The same parts as those in the first embodiment described above will be omitted, and different parts will be described. The first embodiment is configured to determine the calculation result and the video data transmitted and received after the display control ECU 2 and the meter apparatus 3 are activated, and determine the reliability of the video data. However, in the second embodiment, the display control ECU 2 and the meter apparatus 3 determine the signals transmitted and received when the activating factor occurs or when the communication returns, to determine the reliability of the video data.

As shown in FIGS. 10 and 11, when the controller 3a detects the occurrence of the activating factor or the return of communication in the meter apparatus 3, the controller 3a starts the activating process of the communication circuit of the signal conversion IC 3e (B41). When the controller 3a completes the activating process of the communication circuit of the signal conversion IC3e, the controller 3a determines whether or not the disconnection is detected (B42). When the controller 3a determines that the disconnection is not detected (B42: NO), the controller 3a waits for the reception of the drawing data from the display control ECU 2. When the controller 3a determines that the disconnection is detected (B42: YES), the controller 3a returns to step B41, resets the signal conversion IC 3e, and repeats step B41 and subsequent steps.

When the display control ECU 2 detects the occurrence of an activating factor or the return of communication, the controller 2a starts the activating process of the communication circuit of the first signal conversion IC 2f (A41). When the controller 2a completes the activating process of the communication circuit of the first signal conversion IC 2f, the controller 2a determines whether or not the disconnection is detected (A42). When the controller 2a determines that the disconnection is not detected (A42: NO), the controller 2a transmits the drawing data from the first signal conversion IC 2f to the meter apparatus 3 (A43), and waits for the reception of the status signal from the meter apparatus 3. When the controller 3a determines that the disconnection is detected (A42: YES), the controller 3a returns to step A41, resets the first signal conversion IC 2f, and repeats steps A41 and subsequent steps.

In the meter apparatus 3, when the controller 3a detects the reception of the drawing data from the display control ECU 2 by the signal conversion IC 3e (B43), the controller 3a determines whether or not the reception of the drawing data is within the specified time. (B44). When the controller 3a determines that the reception of the drawing data is within the specified time (B44: YES), the controller 3a transmits a status signal indicating that the reception of the drawing data is normal to the display control ECU 2 from the signal conversion IC 3e (B45), and waits for the reception of the status signal from the display control ECU 2. When the controller 3a determines that the reception of the drawing data is not within the specified time (B44: NO), the controller 3a returns to step B41, resets the signal conversion IC3e, and repeats step B41 and subsequent steps.

In the display control ECU 2, when the controller 2a detects the reception of the status signal from the meter apparatus 3 by the first signal conversion IC 2f (A44), the controller 2a determines whether or not the reception of the status signal is within the specified time specified in advance (A45). When the controller 2a determines that the reception of the status signal is within the specified time (A45: YES), the controller 2a transmits a status signal indicating that the reception of the status signal is normal to the meter apparatus 3 from the first signal conversion IC 2f (A46), and waits for the reception of data from the meter apparatus 3. When the controller 2a determines that the reception of the status signal is not within the specified time (A45: NO), the controller 2a returns to step A41, resets the first signal conversion IC 2f, and repeats step A41 and subsequent steps.

In the meter apparatus 3, when the controller 3a detects the reception of the status signal from the display control ECU 2 by the signal conversion IC 3e (B46), the controller 3a determines whether or not the reception of the status signal is within the specified time (B47). When the controller 3a determines that the reception of the status signal is within the specified time (B47: YES), the controller 3a transmits the serial data to the display control ECU 2 from the signal conversion IC 3e (B48) and waits for the reception of serial data from the display control ECU 2. When the controller 3a determines that the reception of the status signal is not within the specified time (B47: NO), the controller 3a returns to step B41, resets the signal conversion IC3e, and repeats step B41 and subsequent steps.

In the display control ECU 2, when the controller 2a detects the reception of the serial data from the meter apparatus 3 by the first signal conversion IC 2f (A47), the controller 2a determines whether or not the reception of the serial data is within the specified time specified in advance (A48). When the controller 2a determines that the serial data is received within the specified time (A48: YES), the controller 2a transmits the serial data to the meter apparatus 3 from the first signal conversion IC 2f (A49), and transmits a backlight turning on request to the meter apparatus 3 from the first signal conversion IC 2f (A30). When the controller 2a determines that the serial data is not received within the specified time (A48: NO), the controller 2a returns to step A41, resets the first signal conversion IC2f, and repeats step A41 and subsequent steps.

In the meter apparatus 3, when the controller 3a detects the reception of the serial data from the display control ECU 2 by the signal conversion IC 3e (B49), the controller 3a determines whether or not the reception of the serial data is within the specified time. (B50). When the controller 3a determines that the reception of the serial data is within the specified time (B50: YES), the controller 3a waits for the reception of the backlight turning on request from the display control ECU 2. When the controller 3a determines that the serial data is not received within the specified time (B50: NO), the controller 3a returns to step B41, resets the signal conversion IC3e, and repeats step B41 and subsequent steps.

In the meter apparatus 3, when the controller 3a detects the reception of the backlight turning on request from the display control ECU 2 by the signal conversion IC 3e (B51), the controller 3a determines whether or not the reception of the backlight turning on request is within the specified time specified in advance (B52). When the controller 3a determines that the reception of the backlight turning on request is within the specified time (B52: YES), the controller 3a turns on the backlight 3g (B53). When the controller 3a determines that the reception of the backlight turning on request is not within the specified time (B52: NO), the controller 3a returns to step B41, resets the signal conversion IC3e, and repeats step B41 and subsequent steps.

As described above, in the display control ECU 2, the controller 2a determines the communication interruption or the communication abnormality because the status signal and the serial data from the meter apparatus 3 are not received within the specified time. Thereby the first signal conversion IC 2f is reset, and the communication between the display control ECU 2 and the meter apparatus 3 is reset. In this case as well, the controller 2a may not only reset the communication between the display control ECU 2 and the meter apparatus 3, but also cause the meter apparatus 3 to perform a notification operation, turning off the backlight 3g, or a combination thereof.

In the meter apparatus 3, the controller 3a determines a communication interruption or a communication abnormality because the drawing data, the status signal, the serial data, or the backlight turning on request from the display control ECU 2 is not received within the specified time. Thereby the signal conversion IC 3e is reset, and the communication between the meter apparatus 3 and the display control ECU 2 is reset. In this case as well, the controller 3a may not only reset the communication between the meter apparatus 3 and the display control ECU 2, but also perform a notification operation, turning off the backlight 3g, or a combination thereof.

As described above, according to the second embodiment, the display control ECU 2 determines communication interruption or communication abnormality because the signal transmitted from the meter apparatus 3 is not received within the specified time when the activating factor occurs or the communication returns. After that, it is determined that the video data transmitted from the display control ECU 2 to the meter apparatus 3 is unreliable. Thereby the communication between the display control ECU 2 and the meter apparatus 3 is reset, the meter apparatus 3 is made to perform a notification operation, or turn of the backlight 3g. As such, similar effects to the first embodiment are achieved.

Further, in the meter apparatus 3, the communication interruption or the communication abnormality is determined because the signal transmitted from the display control ECU 2 is not received within the specified time when the activating factor occurs or the communication returns. After that, it is determined that the video data transmitted from the display control ECU 2 to the meter apparatus 3 is unreliable. Thereby the communication between the meter apparatus 3 and the display control ECU 2 is reset, a notification operation is performed, or the backlight 3g is turned off. As such, similar effects to the first embodiment are achieved.

### Third Embodiment

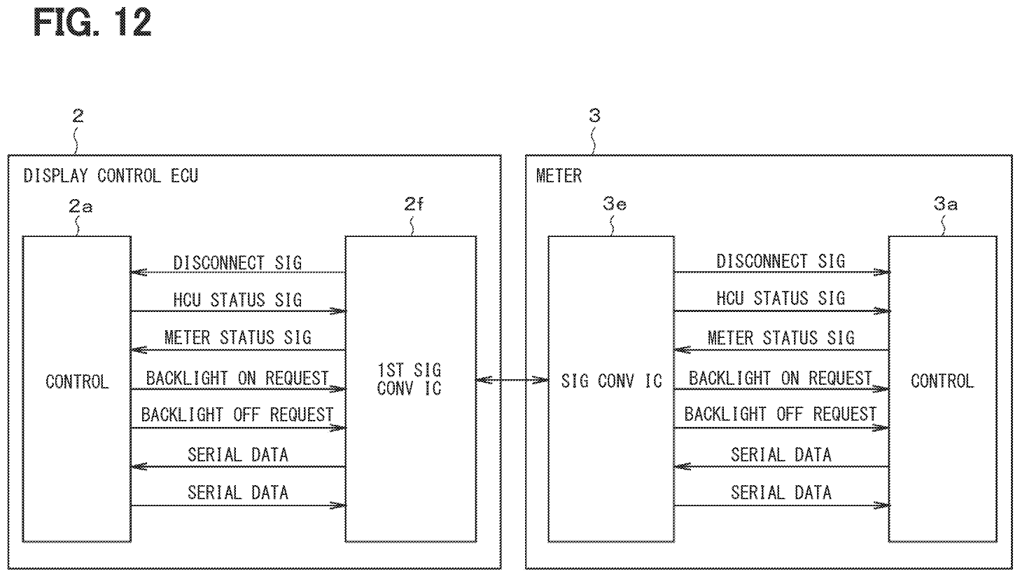

Next, the third embodiment will be described with reference to FIGS. 12 to 16. The same parts as those in the first embodiment described above will be omitted, and different parts will be described. The first embodiment is configured to determine a signal transmitted and received between the display control ECU 2 and the meter apparatus 3 and determine the reliability of video data transmitted from the display control ECU 2 to the meter apparatus 3. However, the third embodiment provides the following configuration. That is, the signals input/output between the controller 2a and the first signal conversion IC 2f are determined inside the display control ECU 2. The signals input/output between the controller 3a and the signal conversion IC 3e are determined inside the meter apparatus 3. The reliability of the video data transmitted from the display control ECU 2 to the meter apparatus 3 is thereby determined.

As shown in FIG. 12, in the display control ECU 2, the controller 2a transmits and receives various signals and data to and from the first signal conversion IC 2f. Such signals and data include disconnection detection signal, HCU status signal indicating the status of the display control ECU 2, meter status signal indicating the status of the meter apparatus 3, backlight turning on request, backlight turning off request, and serial data. In the meter apparatus 3, the controller 3a transmits and receives various signals and data to and from the signal conversion IC 3e. Such signals and data include disconnection detection signal, HCU status signal, meter status signal, backlight turning on request, backlight off request, and serial data.

As a process performed by the controller 2a in the display control ECU 2, a case where an input of a disconnection detection signal is detected and a case where a communication interruption or a communication abnormality of serial data is detected will be described.

(1-1) When the Controller 2a Detects the Input of the Disconnection Detection Signal

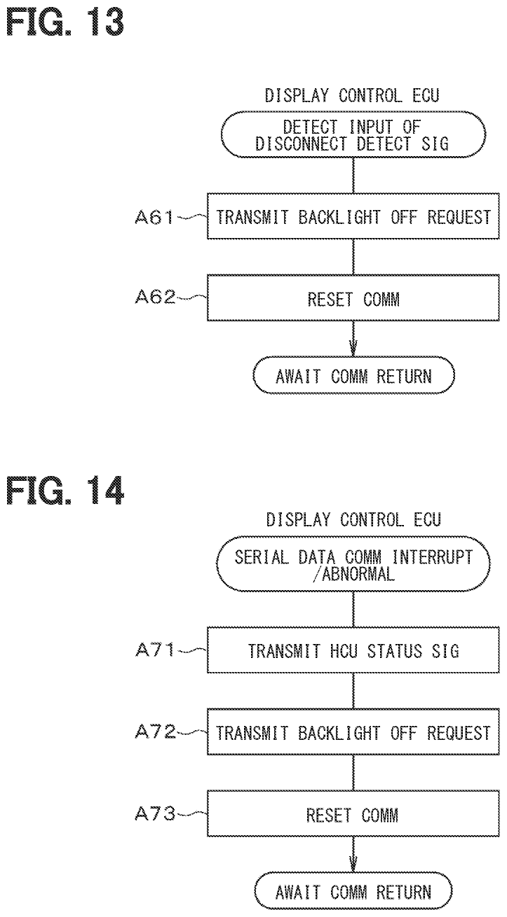

As shown in FIG. 13, when the controller 2a detects the input of the disconnection detection signal from the first signal conversion IC 2f, the controller 2a outputs a backlight turning off request to the first signal conversion IC 2f and causes the first signal conversion IC 2f to transmit a backlight turning off request to the meter apparatus 3 (A61) to turn off the backlight 3g of the meter apparatus 3. The controller 2a resets the first signal conversion IC 2f, resets the communication between the display control ECU 2 and the meter apparatus 3 (A62), shifts to the communication return standby state, and waits for the communication return.

(1-2) When the Controller 2a Detects a Communication Interruption or Communication Abnormality of Serial Data

As shown in FIG. 14, when the controller 2a detects the communication interruption or communication abnormality of the serial data, the controller 2a outputs an HCU status signal indicating the communication interruption or communication abnormality of the serial data to the first signal conversion IC 2f, and causes the first signal conversion IC 2f to transmit the HCU status signal to the meter apparatus 3 (A71). The controller 2a outputs a backlight turning off request to the first signal conversion IC 2f, and causes the first signal conversion IC 2f to transmit a backlight turning off request to the meter apparatus 3 (A72), to turn off the backlight 3g of the meter apparatus 3. The controller 2a resets the first signal conversion IC 2f, resets the communication between the display control ECU 2 and the meter apparatus 3 (A73), shifts to the communication return standby state, and waits for the communication return. In this case as well, the controller 2a may not only reset the communication between the display control ECU 2 and the meter apparatus 3, but may also cause the meter apparatus 3 to perform a notification operation, or may combine them.

A case where an input of a disconnection detection signal is detected and a case where a communication interruption or a communication abnormality of serial data is detected as a process performed by the controller 3a in the meter apparatus 3 will be described.

(2-1) When the Controller 3a Detects the Input of the Disconnection Detection Signal

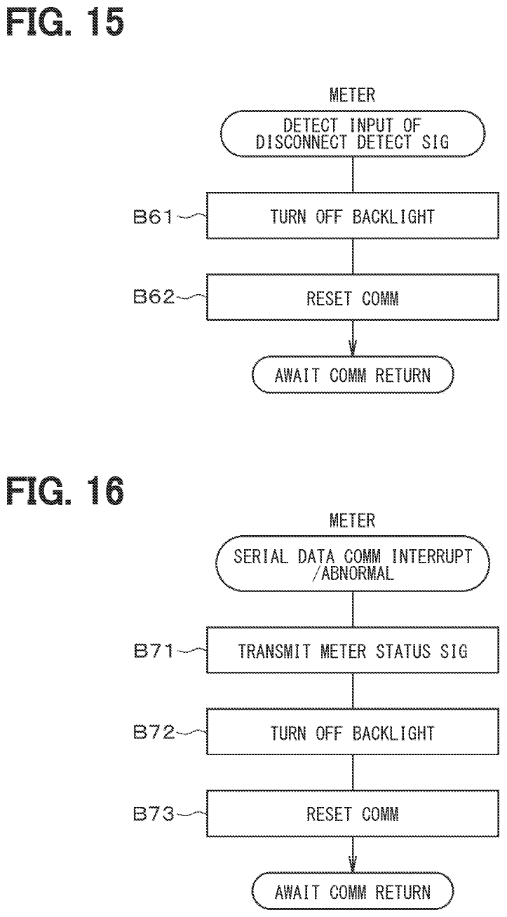

As shown in FIG. 15, when the controller 3a detects the input of the disconnection detection signal from the signal conversion IC 3e, the backlight 3g is turned off (B61). The controller 3a resets the signal conversion IC 3e, resets the communication between the meter apparatus 3 and the display control ECU 2 (B62), shifts to the communication return standby state, and waits for the communication return.

(2-2) When the Controller 3a Detects a Communication Interruption or Communication Abnormality of Serial Data

As shown in FIG. 16, when the controller 3a detects the communication interruption or communication abnormality of the serial data, the controller 3a outputs a meter status signal indicating the communication interruption or communication abnormality of the serial data to the signal conversion IC 3e, and causes the signal conversion IC 3e to transmit the meter status signal to the display control ECU 2 (B71). The controller 3a turns off the backlight 3g (B72). The controller 3a resets the signal conversion IC 3e, resets the communication between the meter apparatus 3 and the display control ECU 2 (B73), shifts to the communication return standby state, and waits for the communication return. In this case as well, the controller 3a may not only reset the signal conversion IC 3e to reset the communication between the meter apparatus 3 and the display control ECU 2, but also perform a notification operation, or combine them.

As described above, according to the third embodiment, in the display control ECU 2, it is determined that the signal input/output between the controller 2a and the first signal conversion IC 2f is interrupted or has a communication abnormality. Then, it is determined that the video data transmitted from the display control ECU 2 to the meter apparatus 3 is unreliable. Thereby the communication between the display control ECU 2 and the meter apparatus 3 is reset, the meter apparatus 3 is made to perform a notification operation, and turn off the backlight 3g. As such, similar effects to the first embodiment are achieved.

Further, in the meter apparatus 3, it is determined that the signal input/output between the controller 3a and the signal conversion IC 3e is interrupted or has a communication abnormality. Then, it is determined that the video data transmitted from the display control ECU 2 to the meter apparatus 3 is unreliable. Thereby the communication between the display control ECU 2 and the meter apparatus 3 is reset, a notification operation is performed, and the backlight 3g is turned off. As such, similar effects to the first embodiment are achieved.

### Other Embodiments

The present disclosure has been described in accordance with the embodiments, but it is understood that the present disclosure is not limited to the embodiments and structures. The present disclosure incorporates various modifications and variations within the scope of equivalents. Additionally, various combinations and configurations, as well as other combinations and configurations including more, less, or only a single element, are within the scope and spirit of the present disclosure.

As the display 3f of the meter apparatus 3 and the display 4f of the center display apparatus 4, a TFT liquid crystal display that requires backlight 3g and 4g has been exemplified. However, an organic EL (Electro Luminescence) display that does not require backlight 3g or 4g may be adopted.

Not only when it is determined that the video data transmitted from the display control ECU 2 to the meter apparatus 3 is unreliable, but also when it is determined that the display function of the display 3f of the meter apparatus 3 has failed, the meter apparatus 3 may perform a notification operation. Even in this case, as a notification operation, for example, a warning icon may be displayed on the display 3f, a warning sound may be output from the speaker 3i, the indicator 3k may be blinked, the ambient lighting may be performed to light the outer peripheral portion of the meter apparatus 3 in red. Further, for example, if the display control ECU 2 and the meter apparatus 3 are configured to be capable of wireless communication with the mobile device, the display control ECU 2 and the meter apparatus 3 may transmit a notification signal to the mobile device. The mobile device may thereby be caused to issue a notification of the failure of the display function of the display 3f.

When it is determined that the display function of the display 4f of the center display apparatus 4 has failed, the meter apparatus 3 may be made to perform a notification operation. Even in this case, as a notification operation, for example, a warning icon may be displayed on the display 3f, a warning sound may be output from the speaker 3i, the indicator 3k may be blinked, the ambient lighting may be performed to light the outer peripheral portion of the meter apparatus 3 in red. Further, for example, if the display control ECU 2 and the meter apparatus 3 are configured to be capable of wireless communication with the mobile device, the display control ECU 2 and the meter apparatus 3 may transmit a notification signal to the mobile device to cause the mobile device to issue a notification of a failure of the display function of the display 3f.

The controller, which may also be referred to as a controller circuit, such as the controller 2a, the controller 3a, the controller 4a, and methods thereof described in the present disclosure in the above embodiments may be implemented by one or more special-purpose computers. Such computers may be created (i) by configuring (a) a memory and a processor programmed to execute one or more particular functions embodied in computer programs, or (ii) by configuring (b) a processor provided by one or more special purpose hardware logic circuits, or (iii) by configuring a combination of (a) a memory and a processor programmed to execute one or more particular functions embodied in computer programs and (b) a processor provided by one or more special purpose hardware logic circuits. The computer program may be stored, as an instruction executed by a computer, in a computer-readable non-transitory tangible storage medium.

For reference to further explain features of the present disclosure, the description is added as follows.

There is known a display control system including (i) a display apparatus with a display and (ii) a display control apparatus for controlling a video displayed on the display in the display apparatus.

In this type of display control system, when video data is transmitted from the display control apparatus to the display apparatus, the video corresponding to the video data is displayed on the display apparatus. For example, if the display apparatus is an in-vehicle meter apparatus, video data is transmitted from the display control apparatus to the meter apparatus, so that, for example, videos such as the remaining amount of fuel and the mileage are displayed on the meter apparatus. That is, the above configuration is a configuration in which video data is transmitted from the display control apparatus to the display apparatus, so that the video corresponding to the video data is displayed on the display apparatus. In such a configuration, in the display apparatus, it is impossible to determine whether the image displayed on the display is a correct video or an incorrect video. Thus, there is need for a mechanism for determining the reliability of video data transmitted from the display control apparatus to the display apparatus and appropriately dealing with the determination that the data is unreliable.

It is thus desired to take appropriate measures when it is determined that the video data transmitted from the display control apparatus to the display apparatus is unreliable.

Aspects of the present disclosure described herein are set forth in the following clauses.

According to an aspect of the present disclosure, a display control apparatus is provided to include a video data transmitter, a first reliability determination unit, and a first predetermined process execution unit. The video data transmitter is a transmitter configured to transmit a video data to a display apparatus. The first reliability determination unit is configured to determine whether the video data transmitted from the video data transmitter to the display apparatus is reliable or unreliable. The first predetermined process execution unit is configured to execute a first predetermined process in response to the first reliability determination unit determining that the video data transmitted from the video data transmitter to the display apparatus is unreliable.

Under the above configuration, the reliability of the video data transmitted from the video data transmitter to the display apparatus is determined. If it is determined that the video data is not reliable, the first predetermined process is performed. As a result, when it is determined that the video data transmitted from the display control apparatus to the display apparatus is unreliable, it is possible to take appropriate measures.

According to another aspect of the present disclosure, a display apparatus is provided to include a video data receiver, a second reliability determination unit, and second predetermined process execution unit. The video data receiver is a receiver configured to receive a video data from a display control apparatus. The display is configured to display a video corresponding to the video data received by the video data receiver. The second reliability determination unit is configured to determine whether the video data received from the display control apparatus by the video data receiver is reliable or unreliable. The second predetermined process execution unit is configured to execute a second predetermined process in response to the second reliability determination unit determining that the video data received from the display control apparatus by the video data receiver is unreliable.

Under the above configuration, the reliability of the video data received by the video data receiver from the display control apparatus is determined. If it is determined that the video data is not reliable, the second predetermined process is executed. As a result, when it is determined that the video data transmitted from the display control apparatus to the display apparatus is unreliable, it is possible to take appropriate measures.

According to yet another aspect of the present disclosure, a display control system is provided to include a display control apparatus, a display apparatus, a reliability determination unit, and a process execution unit. The display control apparatus is configured to transmit video data. The display apparatus is configured to receive the video data from the display control apparatus and display a video corresponding to the received video data on a display. The reliability determination unit is configured to determine whether the video data transmitted from the display control apparatus to the display apparatus is reliable or unreliable. The process execution unit is configured to execute a predetermined process in response to the reliability determination unit determining that the video data transmitted from the display control apparatus to the display apparatus is unreliable. Under the above configuration, as a result, when it is determined that the video data transmitted from the display control apparatus to the display apparatus is unreliable, it is possible to take appropriate measures.

What is claimed is:

1. A display control apparatus comprising:
a video data transmitter being a transmitter configured to transmit a video data to a display apparatus;
a first reliability determination unit configured to determine whether the video data transmitted from the video data transmitter to the display apparatus is reliable or unreliable; and
a first predetermined process execution unit configured to execute a first predetermined process in response to the first reliability determination unit determining that the video data transmitted from the video data transmitter to the display apparatus is unreliable.

2. The display control apparatus according to claim 1, wherein:
the first reliability determination unit is further configured to determine whether or not a signal transmitted to or received from the display apparatus undergoes a communication interruption, or a communication abnormality, or both the communication interruption and the communication abnormality, to determine whether the video data transmitted from the video data transmitter to the display apparatus is reliable or unreliable.

3. The display control apparatus according to claim 1, further comprising:
a first controller configured to control transmitting the video data from the video data transmitter to the display apparatus,
wherein:
the first reliability determination unit is further configured to determine whether or not a signal input or output between the first controller and the video data transmitter undergoes a communication interruption, or a communication abnormality, or both the communication interruption and the communication abnormality, to determine whether the video data transmitted from the video data transmitter to the display apparatus is reliable or unreliable.

4. The display control apparatus according to claim 1, wherein:
the first predetermined process execution unit is further configured to reset the video data transmitter as the first predetermined process.

5. The display control apparatus according to claim 1, wherein:
the first predetermined process execution unit is further configured to cause the display apparatus to perform a notification operation as the first predetermined process.

6. The display control apparatus according to claim 1, wherein:
the first predetermined process execution unit is configured to turn off a backlight in the display apparatus as the first predetermined process.

7. A display apparatus, comprising:
a video data receiver being a receiver configured to receive a video data from a display control apparatus;
a display configured to display a video corresponding to the video data received by the video data receiver;
a second reliability determination unit configured to determine whether the video data received from the display control apparatus by the video data receiver is reliable or unreliable; and
a second predetermined process execution unit configured to execute a second predetermined process in response to the second reliability determination unit determining that the video data received from the display control apparatus by the video data receiver is unreliable.

8. The display apparatus according to claim 7, wherein:
the second reliability determination unit is further configured to determine whether or not a signal transmitted to or received from the display control apparatus undergoes a communication interruption, or a communication abnormality, or both the communication interruption and the communication abnormality, to determine whether the video data received from the display control apparatus by the video data receiver is reliable or unreliable.

9. The display apparatus according to claim 7, further comprising:
a second controller configured to control receiving the video data from the display control apparatus to the video data receiver,
wherein:
the second reliability determination unit is further configured to determine whether or not a signal input or output between the second controller and the video data receiver undergoes a communication interruption, or a communication abnormality, or both the communication interruption and the communication abnormality, to determine whether the video data received from the display control apparatus by the video data receiver is reliable or unreliable.

10. The display apparatus according to claim 7, wherein:
the second predetermined process execution unit is further configured to reset the video data receiver as the second predetermined process.

11. The display apparatus according to claim 7, wherein:
the second predetermined process execution unit is further configured to execute a notification operation as the second predetermined process.

12. The display apparatus according to claim 7, wherein:
the second predetermined process execution unit is further configured to turn off a backlight as the second predetermined process.

13. A display control system, comprising:
a display control apparatus configured to transmit a video data;
a display apparatus configured to receive the video data from the display control apparatus and display a video corresponding to the received video data on a display;
a reliability determination unit configured to determine whether the video data transmitted from the display control apparatus to the display apparatus is reliable or unreliable; and
a process execution unit configured to execute a predetermined process in response to the reliability determination unit determining that the video data transmitted from the display control apparatus to the display apparatus is unreliable.

14. A non-transitory computer readable storage medium storing a reliability determination computer program product to a controller in a display control apparatus configure to transmit a video data to a display apparatus, the reliability determination computer program product comprising instructions configured to, when executed by at least one processor in the controller, cause the at least one processor to:
determine whether the video data transmitted from the display control apparatus to the display apparatus is reliable or unreliable; and
execute a first predetermined process in response to determining that the video data transmitted from the display control apparatus to the display apparatus is unreliable.

15. A non-transitory computer readable storage medium storing a reliability determination computer program product to a controller in a display apparatus configured to receive a video data from a display control apparatus, the reliability determination computer program product comprising instructions configured to, when executed by at least one processor in the controller, cause the at least one processor to:
determine whether a video data received from the display control apparatus by the display apparatus is reliable or unreliable; and
execute a second predetermined process in response to determining that the video data received from the display control apparatus by the display apparatus is unreliable.

16. The display control apparatus according to claim 1, further comprising:
a first controller communicably coupled to the video data transmitter, the first controller being configured to implement the first reliability determination unit and the first predetermined process execution unit.

17. The display apparatus according to claim 7, further comprising:
a second controller communicably coupled to the video data receiver, the second controller being configured to implement the second reliability determination unit and the second predetermined process execution unit.

18. The display control system according to claim 13, further comprising:
at least one controller provided to be included in the display control apparatus or the display apparatus, the at least one controller being configured to implement the reliability determination unit and the predetermined process execution unit.
